(19) United States
(12) Patent Application Publication
(10) Pub. No.: US 2015/0222142 A1
(43) Pub. Date: Aug. 6, 2015

(54) Contactless Charging Device

(71) Applicant: Tyco Electronics Japan G.K., Kanagawa (JP)

(72) Inventor: Hiroshi Shirai, Kanagawa (JP)

(73) Assignee: Tyco Electronics Japan G.K., Kanagawa (JP)

(21) Appl. No.: 14/613,468

(22) Filed: Feb. 4, 2015

(30) Foreign Application Priority Data
Feb. 4, 2014 (JP) 2014-019210

(51) Int. Cl. H02J 7/02; H02J 7/00

(52) U.S. Cl. CPC H02J 7/025; H02J 7/0044

(57) ABSTRACT

A contactless charging device is disclosed having a power connector, a cable, and a charging head. The cable has a first end connected to the power connector. The charging head is connected to an opposite second end of the cable, and has a magnet or a magnetic substance, and an electromagnetic coil.

### CROSS-REFERENCE TO RELATED APPLICATIONS

This application claims the benefit of the filing date under 35 U.S.C §119 (a)-(d) of Japanese Patent Application No. 2014-019210 dated Feb. 4, 2014.

### FIELD OF THE INVENTION

The invention generally relates to an electrical charging device, and more specifically, to a contactless electrical charging device.

### BACKGROUND

Conventionally, a contactless charging device contactlessly charging a mobile terminal, such as a mobile telephone or a mobile tablet terminal is known (for example, see JP 2009-501000 A). This conventional type of contactless charging device has a shape of a tray or a table to put a mobile terminal on. Further, the tray or the table has inside an electromagnetic coil or the like for contactless charging. When the mobile terminal is placed on the tray or table and an electrical current is passed through the electromagnetic coil, the mobile terminal is charged by electromagnetic induction. The contactless charging device is convenient since the mobile terminal can be easily charged only by placing the mobile terminal thereon. Further, the contactless charging device is also expected to contribute to waterproofness and dustproofness of the contactless charging device. JP 2009-501000 A also describes performing wireless communication with a mobile terminal as well as charging the mobile terminal on the contactless charging device.

The above-described contactless charging device having a shape of a tray or a table is of a stationary type that is always left in the same place, and is inconvenient to carry along with the mobile terminal. For example, a case that the mobile terminal is taken out on a private trip or on a business trip is imagined. A destination of the private trip or the business trip cannot ordinarily be expected to have a contactless charging facility.

Therefore, even a mobile terminal capable of contactless charging needs to be equipped with a connector connecting with a cable for charging, along with components for contactless charging. When charging the mobile terminal at a destination of a private trip or on a business trip is expected, the cable for charging is taken out together with the mobile terminal. Then, charging is performed by connecting the cable for charging to a connector of the mobile terminal. The fact that the mobile terminal needs to be equipped with the connector for charging results in a difficulty of complete waterproofness and dustproofness of the mobile terminal. In addition, the need to be equipped with the connector is also disadvantageous in terms of the cost and dimensions of the mobile terminal.

In view of these circumstances, an object of the present invention is to provide a contactless charging device having excellent portability.

### SUMMARY

A contactless charging device has a power connector, a cable, and a charging head. The cable has a first end connected to the power connector. The charging head is connected to an opposite second end of the cable, and has a magnet or a magnetic substance, and an electromagnetic coil.

### BRIEF DESCRIPTION OF THE DRAWINGS

The invention will now be described by way of example, with reference to the accompanying Figures, of which:

FIG. 1 is a perspective view of a contactless charging device;

FIG. 2 is a perspective view of the contactless charging device in which a charging head has been connected to a mobile terminal;

FIG. 3 is a perspective view of an attracting surface of the charging head;

FIG. 4 is a perspective view showing an internal structure of the charging head;

FIG. 5 is a perspective view of a contactless charging device;

FIG. 6 is an enlarged perspective view of a charging head of the contactless charging device of FIG. 5;

FIG. 7 is a perspective view of the contactless charging device of FIG. 5 where the charging head has been connected to a mobile terminal;

FIG. 8 is an exploded view of the charging head;

FIG. 9 is a perspective view showing an internal structure of the charging head;

FIG. 10 is a partial perspective view of a top of a shell having a coil supporting member;

FIG. 11 is a partial perspective view of a bottom of the shell having the coil supporting member; and

FIG. 12 is a perspective view of a charging head circuit board.

### DETAILED DESCRIPTION OF THE EMBODIMENT(S)

The invention is described below with reference to FIGS. 1-12.

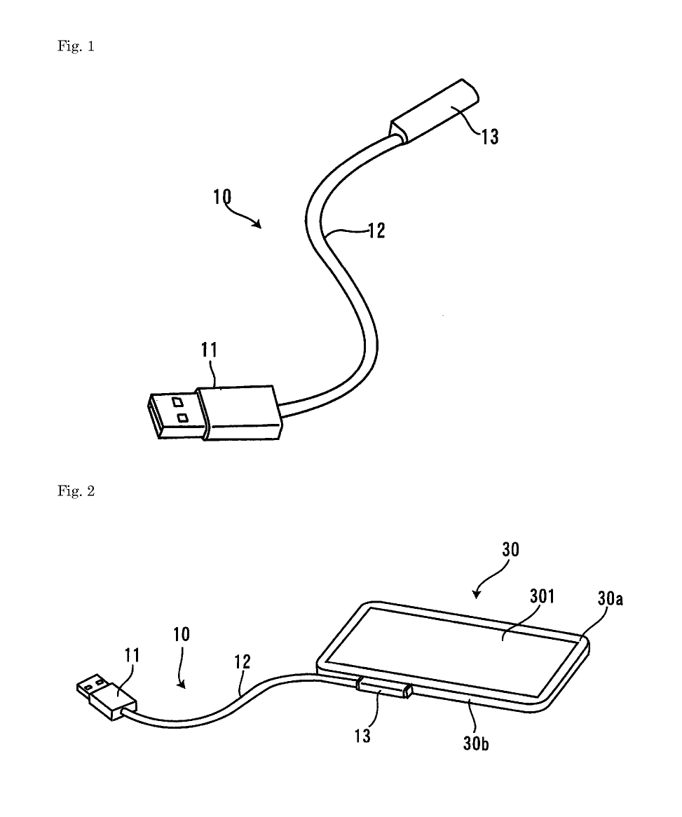

In the embodiments of FIGS. 1 and 2, a contactless charging device 10 has a USB connector 11, a cable 12, and a charging head 13. It should be noted that the cable 12 depicted herein is short in length for convenience of diagrammatic representation, but a cable having a suitable length may be used as the cable 12.

In addition, a mobile terminal 30 has a display screen 301 positioned on a first surface 30a thereof.

The USB connector is a connector conforming to USB (Universal Serial Bus) standards. The USB connector 11 can be supplied with electrical power from various electronic devices or power source adapters provided with a mating connector conforming to the USB standards, such as a laptop personal computer. The USB connector 11 corresponds to an example of a power connector.

The cable 12 has first end connected with the USB connector 11, and serves to receive electrical power via the USB connector 11 and transmit the electrical power to an opposite second end.

The charging head 13 is attracted to a connecting surface 30b of the mobile terminal 30. The charging head 13 is connected to the second end of the cable 12, is supplied with electrical power from the cable 12, and serves to charge the mobile terminal 30.

In an embodiment of FIG. 3, an attracting surface 13a of the charging head 13 has a thickness approximately equal to or less than a thickness of the mobile terminal 30, namely, having substantially the same width as the width of a connecting surface 30b of the mobile terminal 30. Embedded magnets 131 are positioned proximate to each longitudinal end of the attracting surface 13a, and have an exposed surfaces facing outward. The charging head 13 is magnetically attracted to the corresponding connecting surface 30b of the mobile terminal 30 through the magnetic attraction between the magnet 131 and a magnetic substance or a magnet embedded in the mobile terminal 30, such that the charging head 13 may be precisely connected to the connecting surface 30b at a predetermined location.

While exposed surface of the magnet 131 is exposed from the attracting surface 13a, the remaining portions of the magnet 131 may be embedded into the charging head 13, such that the attracting surface 13a covers those portions of the magnet 131 so as not to be exposed from the attracting surface 13a.

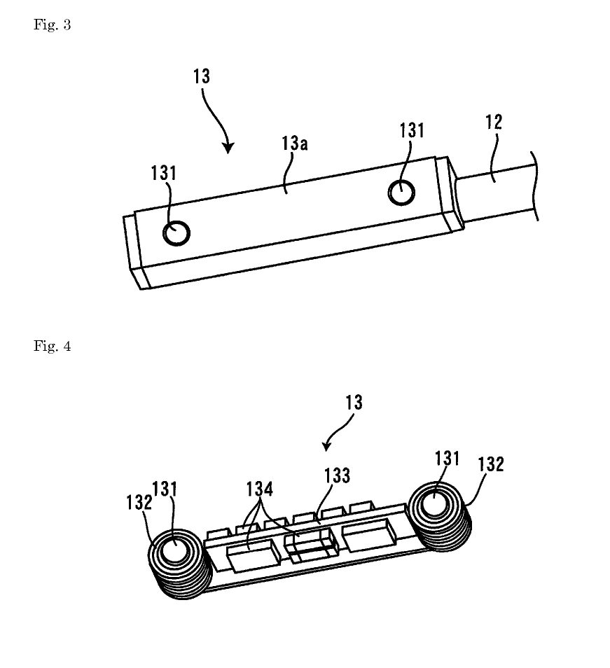

In an embodiment of FIG. 4, electromagnetic coils 132 are disposed around the magnets 131 for attraction to the mobile terminal 30. That is, the magnets 131 for attraction are directly used as magnetic cores of the coils 132. Further, a circuit board 133 is positioned in the charging head 13, having a plurality of electronic components 134 are mounted thereto. The electronic components 134 are circuits serving to convert the electrical power received via the cable 12 into electrical power having a frequency suitable for charging, and for exciting the electromagnetic coils 132. Magnets or magnetic substances, to which the charging head 13 is attracted, and coils (not shown) for receiving electrical power of an electromagnetic field are positioned inside the connecting surface 30b (see FIG. 2) of the mobile terminal 30. When the electromagnetic coils 132 of the charging head 30 are excited, an electromagnetic field is formed. Then, electrical power is transmitted to the coils of the mobile terminal 30 through the electromagnetic field, and the mobile terminal 30 is charged with the electrical power.

The magnets 131 for attracting the charging head 13 to the mobile terminal 30 are directly used as magnetic cores of the electromagnetic coils 132, but the magnet 131 and the magnetic core may be separate bodies. If the magnet 131 and the magnetic core of the electromagnetic coil 132 are constituted as separate bodies, a material exhibiting better performance can be selected as the magnetic core, so that charging efficiency can be improved. Therefore, in an embodiment, separate bodies are used for the magnet 131 and the magnetic core of the electromagnetic coil 132. In another embodiment, the same bodies are used for both the magnet 131 and the magnetic core of the electromagnetic coil 132 to reduce manufacturing costs and overall dimensions.

In an embodiment, the electronic circuit 134 for electrical power conversion is positioned inside the charging head 13. However, in an embodiment, the electronic circuit 134 for electrical power conversion is positioned inside the USB connector 11, or may be positioned in the middle of the cable 12. Such embodiments allow for electronic components used in wireless communication with the mobile terminal 30 to be built in the charging head 13, without increasing the size of the charging head 13.

In an embodiment, the magnet 131 is used for attracting the mobile terminal 30. In another embodiment, the mobile terminal 30 has magnet similar to the magnet 131, and the charging head 13 has a magnetic material attracted to the magnet of the mobile terminal 30.

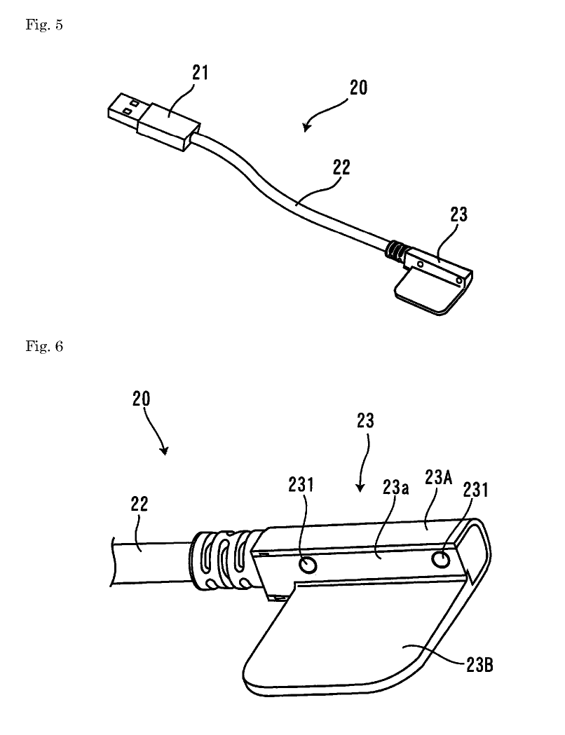

In the embodiment of FIGS. 5-7, a contactless charging device 20 has a USB connector 21, a cable 22, and a charging head 23, substantially similar to the above described contactless charging device 10. The USB connector 21 and the cable 22 are substantially similar to the USB connector 11 and the cable 12, respectively, of the contactless charging device 10 described above, so therefore a description of the USB connector 21 and the cable 22 has been omitted. However, as described below, the charging head 23 of the contactless charging device 20 includes an electronic circuit for wireless communication. Therefore, the USB connector 21 and the cable 22 serve to transmit electrical power and to additionally to transmit a signal for communication.

In an embodiment of FIG. 6, the charging head 23 has a base sleeve 23A, and a coil supporting member 23B extending from the base sleeve 23A. The base sleeve 23A has a complimentary shape to the charging head 13 in the contactless charging device 10 described above. Two embedded magnets 231 are positioned in the charging head 23, proximate to the longitudinal ends, and have an exposed surface facing outward from an attracting surface 23a of the base sleeve 23A. These magnets 231, unlike the magnet 131 described above, do not serve as magnetic cores, but serve only for attraction to a mobile terminal 40.

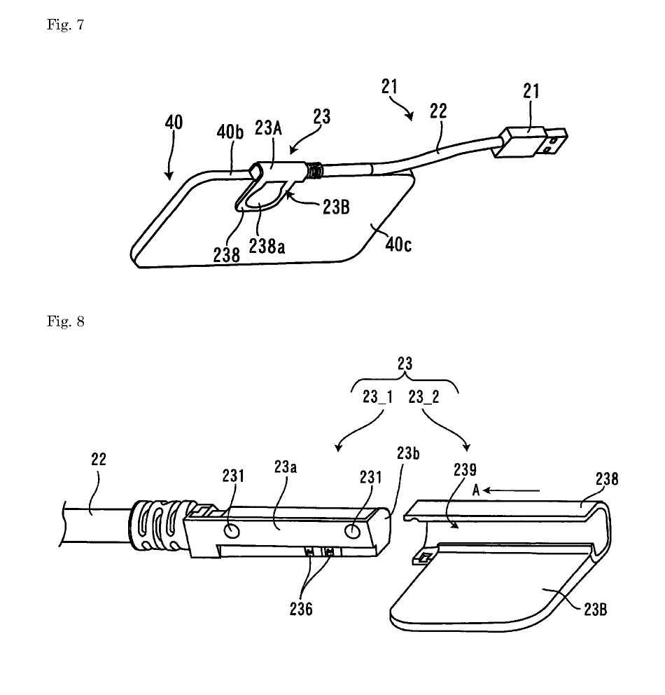

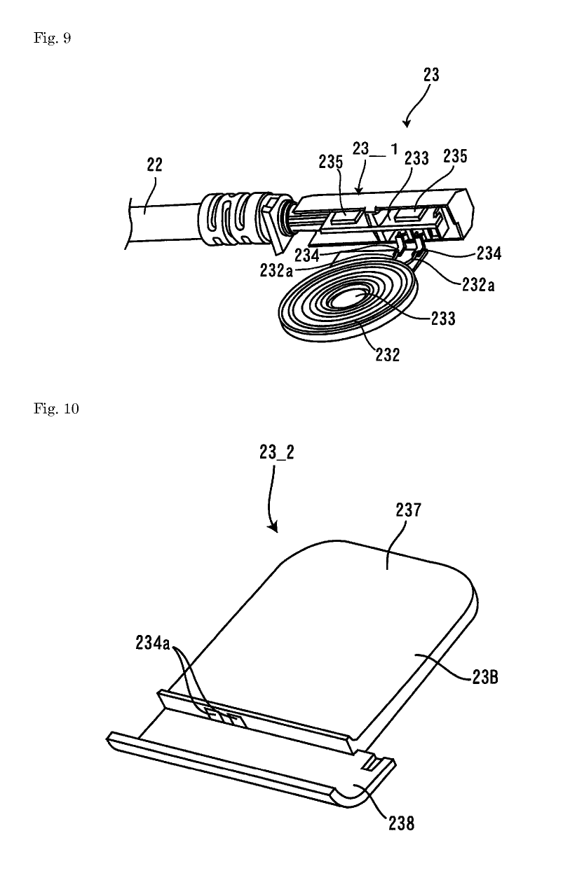

In an embodiment of FIG. 7, the attracting surface 23a of the base sleeve 23A, is magnetically attracted to a corresponding connecting surface 40b of the mobile terminal 40. When the charging head 23 is attached to the mobile terminal 40, the coil supporting member 23B abuts a second surface 40c of the mobile terminal 40. An electromagnetic coil 232 (see FIG. 9) is positioned in the coil supporting member 23B. A coil cover 238a, covering the electromagnetic coil 232, is positioned in a complimentary cover receiving space (not shown) disposed on an outward facing surface 238 (shown in FIG. 7) of the coil supporting member 23B. The mobile terminal 40, substantially the same as the mobile terminal 30 discussed above, has a display screen 301 on a first surface corresponding to the first surface 30a of the mobile terminal 30. The second surface 40c of the mobile terminal 40, shown in FIG. 7, is a second surface positioned opposite to the first surface having the display screen. The mobile terminal 40 is provided with a magnet or a magnetic substance embedded inside the connecting surface 40b, to which the magnet 231 of the charging head 23 is attracted. Therefore, the base sleeve 23A of the charging head 23 is magnetically attracted to the connecting surface 40b of the mobile terminal 40 with sufficient positional precision.

In an embodiment of FIG. 8, the charging head 23 includes a body 23_1 and a shell 23_2. The body 23_1 includes the attracting surface 23a. The body 23_1 has a structure in which the attracting surface 23a and a terminating end surface 23b, positioned on the longitudinal end furthermost from the cable 22, face outward in an assembled state, being exposed to an environment.

The shell 23_2 includes the coil supporting member 23B and a sleeve 238. The sleeve 238 has a body receiving space (not labeled), and an attracting surface receiving opening 239 extending longitudinal along a side facing the coil supporting member 23B. When the body 23-1 is positioned in the body receiving space, the attracting surface 23a is positioned in the attracting surface receiving opening 239, facing outward towards the coil supporting member 23B. The charging head 23 is assembled by sliding the shell 23_2 in an insertion direction A such that the body 23_1 is received into the body receiving space of the sleeve 238.

In an embodiment of FIG. 9, the attracting surface 23a of the body 23_1 and the magnets 231, as well as the shell 23_2, have been removed to show the electromagnetic coil 232, and a magnetic core 233 positioned in a center of the electromagnetic coil 232. The electromagnetic coil 232 and the magnetic core 233 are positioned in the shell 23_2.

The body 23_1 has a circuit board 233 in addition to the magnets 231 described above. Circuit components (not shown) for exciting the electromagnetic coil 232, which are substantially similar to the circuit components 134, are mounted on the circuit board 233. In addition, circuit components 235 for wireless communication with the mobile terminal 40 are mounted on the circuit board 233. Therefore, the charging head 23 serves to both charge the mobile terminal 40 and wirelessly communicate with the mobile terminal 40. In an embodiment, the electromagnetic coil 232 is positioned in the coil supporting member 23B, at a distance from the base sleeve 23A. Therefore, the circuit components 235 for wireless communication are positioned in the base sleeve 23A without increasing the size of the base sleeve 23A.

As described above, the coil supporting member 23B of the charging head 23 includes the magnetic core 233 or the like, and the electromagnetic coil 232 is positioned around the magnetic core 233. As such, the electromagnetic coil 232 is positioned in the coil supporting member 23B, which in turn, abuts the second surface 40c of the mobile terminal 40. Therefore, in an embodiment, the electromagnetic coil 232, which is larger in size than the electromagnetic coil 132, provides an increased charge amount per unit hour. The mobile terminal 40, to which the contactless charging device 20 connected, has a complementary electromagnetic coil for receiving electrical power in a region of the second surface 40c abutting on the coil supporting member 23B, when the base sleeve 23A has been magnetically connected to the connecting surface 40b. Both coil leads 232a of a wire forming the electromagnetic coil 232 of the charging head 20 are soldered to metal terminals 234 (see FIG. 11 described below), and connected to the circuit board 233 via the terminals 234.

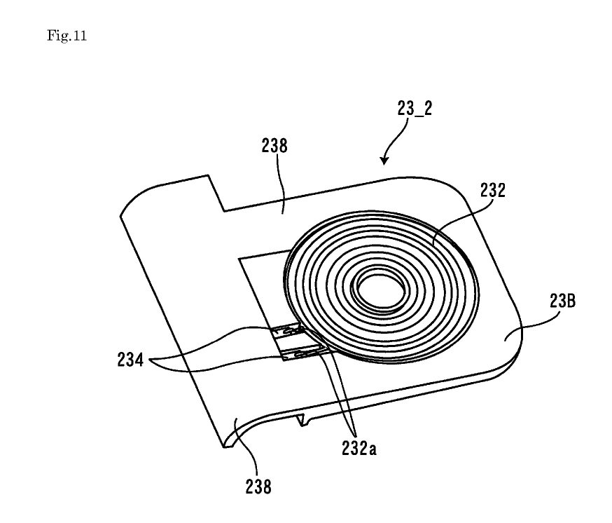

In an embodiment of FIG. 10, a device facing surface 237 of the coil supporting member 23B is the surface abutting the second surface 40c of the mobile terminal 40. Terminal faces 234a of the metal terminals 234 shown in FIG. 9 and FIG. 11 extend through a portion of the sleeve 238 and face into the body receiving space of the sleeve 238. In order to expose the terminal faces 234a of the terminals 234, a portion of the sleeve 238 is removed to form terminal receiving passageways (not labeled). Therefore, the sleeve 238 shown in FIG. 10 differs in shape from the shape of the sleeve 238 shown in FIG. 8.

In an embodiment of FIG. 11, similarly to the embodiment of FIG. 10, a portion of the sleeve 238 is removed to form the terminal receiving passageways (not labeled). Further, the coil cover 238a positioned on the outward facing surface 238 of the coil supporting member 23B has been removed, as well as the magnetic core 233 in the center of the electromagnetic coil 23. FIG. 11 shows both the coil leads 232a of the wire forming the electromagnetic coil 232 being each connected to the two metal terminals 234. Both coil leads 232a of the wire and the terminals 234 are connected together by soldering. Further, as shown in FIG. 10, the terminal faces 234a of the terminals 234 are exposed in the body receiving space of the sleeve 238.

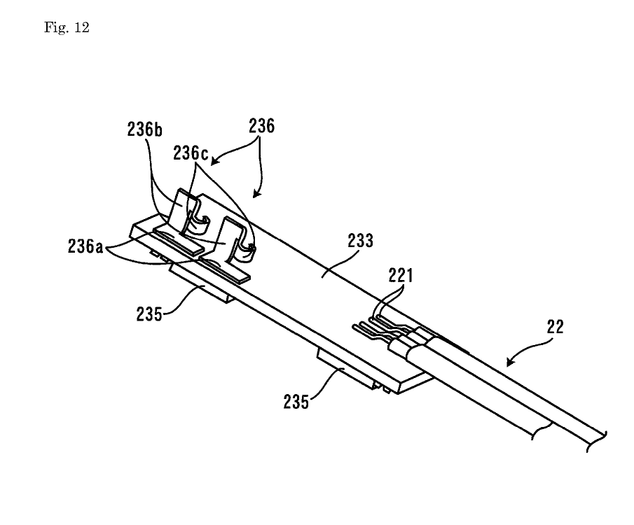

In FIG. 12, a bottom face positioned opposite to a top face of the circuit board 233, and the cable 22 having a jacket stripped off is shown. Core wires 221 of the cable 22 are exposed, and soldered to the circuit board 233.

The two terminals 236 each have a solder connecting portion 236a connected to the circuit board 233 by soldering, an upright portion 236b extending outward from the solder connecting portion 236a, and a contact portion 236c extending from the upright portion 236b and having a curved shape.

As described above with reference to FIG. 8, the charging head 23 is assembled by sliding the shell 23_2 in the insertion direction A. As shown in FIG. 10, the coil leads 232a of the wire forming the electromagnetic coil 232 are soldered to the terminals 234. Further, the terminal faces 234a of the terminals 234 are exposed inside the body receiving space of the sleeve 238. When the shell 23_2 is displaced along the insertion direction A, the terminal faces 234a of the terminal 234 come into pressure contact with the contact portions 236c of the terminals 236 mounted on the circuit board 233. When the contact portions 236c are pressed by the terminals 234, connecting portions between the upright portion 236b and the contact portions 236c are elastically deformed. As a result, the contact portions 236c make elastic contact with the terminals 234 on the shell 23_2 side, and the electromagnetic coil 232 and the circuit board 233 are electrically connected without such a process as soldering.

When the contactless charging device 20 is used, both charging and data communications are performed in a contactless manner. Therefore, the mobile terminal 40 does not need to have a corresponding connector opening. Accordingly, the waterproofness and dustproofness of the mobile terminal 40 can be highly enhanced.

The contactless charging device 20 includes magnets 231 embedded in the attracting surface 23a of the base sleeve 23A that contact the connecting surface 40b of the mobile terminal 40. The charging head 23, similar to the charging head 13, is magnetically attracted to the connecting surface 40b of the mobile terminal 40. In an embodiment, the coil supporting member 23B of the contactless charging device 20 includes a magnet positioned in place of the base sleeve 23A of the charging head 23, such that the coil supporting member 23B is magnetically attracted to the second surface 40c of the mobile terminal 40. In another embodiment, both the base sleeve 23A and the coil supporting member 23B include magnets, such that the base sleeve 23A and the coil supporting member 23B are magnetically attracted to both the connecting surface 40b and the second surface 40c of the mobile terminal 40. In yet another embodiment, the mobile terminal 40 includes a magnet, and the charging head 23 includes a magnetic material that is magnetically attracted to the magnet embedded in the mobile terminal 40.

In an embodiment, the circuit for exciting the electromagnetic coil 232 may be positioned in the USB connector 21, or may be positioned in a portion of the cable 22.

The charging head 23 may also include circuit components 235 for wireless communication with the mobile terminal 40. The wireless communication defined herein can adopt any wireless communication system, and may adopt a Wi-Fi or Bluetooth (registered trademark) technology. Alternatively, if a near field communication technology of a 60 GHz band is used, one user can occupy a communication band, so that even very high-speed communication of a 5 Gbps class, such as USB 3.0, can be performed at a speed similar to a wired communication.

The mobile terminal to be charged by the contactless charging device of the present invention is not limited to a specific type of mobile terminal. The present invention can charge a wide range of general mobile terminals, including, for example, a smartphone and a tablet terminal, and in addition, a portable music player, a laptop personal computer, a digital camera, and the like.

Further, in the embodiments described above, a USB connector is used as a power connector. However, one of ordinary skill in the art would appreciate that the power connector defined in the present invention is not limited to a USB connector, but may be any type of connector as long as the connector can be used for a power source.

Further, the embodiments described above have two embedded magnets 131, 231, but one of ordinary skill in the art would appreciate that in other embodiments, one magnet and a mechanical positioning mechanism, such as a tongue and groove joint structure, may be positioned in the charging head and the mobile terminal.

What is claimed is:

1. A contactless charging device comprising:
a power connector;
a cable having a first end connected to the power connector; and
a charging head connected to an opposite second end of the cable, and having a magnet or a magnetic substance, and
an electromagnetic coil.

2. The contactless charging device of claim 1, wherein the magnet or a magnetic substance magnetically attracted to a mobile terminal having a corresponding magnetic substance or magnet.

3. The contactless charging device of claim 2, wherein the electromagnetic coil is in contactless electrical communication with the mobile terminal.

4. The contactless charging device of claim 3, wherein the charging head contacts a connecting surface of the mobile terminal.

5. The contactless charging device of claim 3, wherein the charging head contacts a region of the mobile terminal that includes a portion of the connecting surface.

6. The contactless charging device of claim 2, wherein the charging head is magnetically attracted to a connecting surface of the mobile terminal.

7. The contactless charging device of claim 2, wherein the charging head wirelessly supplies electrical power to the mobile terminal through the connecting surface.

8. The contactless charging device of claim 2, wherein the mobile terminal has a display screen on a first surface.

9. The contactless charging device of claim 8, wherein the charging head further includes a coil supporting member.

10. The contactless charging device of claim 9, wherein the electromagnetic coil is positioned in the coil supporting member.

11. The contactless charging device of claim 9, wherein the coil supporting member contacts a second surface of the mobile terminal opposite to the first surface.

12. The contactless charging device of claim 10, wherein the electromagnetic coil wirelessly supplies the electrical power to the mobile terminal through the second surface.

13. The contactless charging device of claim 9, wherein the coil supporting member further comprises a sleeve having a charging head receiving space.

14. The contactless charging device of claim 13, wherein the charging head is positioned in the charging head receiving space.

15. The contactless charging device of claim 13, wherein the coil supporting member extends outward from the sleeve and has a plate-like or tab-like shape.

16. The contactless charging device of claim 1, wherein the power connector and the cable transmit electrical power.

17. The contactless charging device of claim 16, wherein the power connector and the cable additionally transmit data.

18. The contactless charging device of claim 17, wherein the charging head further includes a communication module.

19. The contactless charging device of claim 18, wherein the communication module is in wireless communication with a mobile terminal.
